(19) United States
(12) Patent Application Publication
(10) Pub. No.: US 2012/0320346 A1
(43) Pub. Date: Dec. 20, 2012

(54) IMAGE DISPLAY DEVICE AND METHOD FOR CONTROLLING SAME

(76) Inventors: Kazuaki Sakamoto, Tokyo (JP); Yasuhiro Ochiai, Tokyo (JP)

(21) Appl. No.: 13/521,722

(22) PCT Filed: Jan. 19, 2010
(86) PCT No.: PCT/JP2010/050525

§ 371 Date: Aug. 1, 2012

(51) Int. Cl. G03B 21/14

(52) U.S. Cl. 353/101; 353/121

(57) ABSTRACT

The present invention provides an image display device that includes projection lens (150) configured to project an image to a projection surface, and openable/closable lens cover (161) for covering the front of projection lens (150). The image display device includes focus adjustment control unit (320) that adjusts the focus of projection lens (150), and open/close detection unit (160) that detects the opened/closed state of lens cover (160) to notify focus adjustment control unit (320) of the result. Focus adjustment control unit (320) stops the focus adjustment when it is notified of the closing of lens cover (161) by open/close detection unit (160).

### TECHNICAL FIELD

The present invention relates to an image display device that includes a projection lens and an openable/closable lens cover for covering the front of the projection lens, and a method for controlling the same.

### BACKGROUND ART

A certain projector that is one of the image display devices has, in order to improve usability for a user, an autofocus function of automatically adjusting the focus of the projection lens, and an openable/closable lens cover for covering the front of the projection lens.

For example, in a projector having an autofocus function disclosed in Patent Document 1 (JP2007-322791A), the focus is automatically adjusted based on the distance from the projector to the projection screen. This eliminates the necessity of adjusting the focus for the user, and thus does not require any labor and effort.

Concerning the projector that includes the lens cover, there are many projectors having lens cover functions to interrupt the projection of images to the projection screens by closing the lens covers. In the projector of this type, in order to temporarily interrupt the projection of the image during conference or the like, it is only necessary to close the lens cover without cutting off power for the projector. To resume the projection, the lens cover only needs to be opened. There is no need to wait until the image is projected by relighting a light source unit

### CITATION LIST

### Patent Document

Patent Document 1: JP2007-322791A

### SUMMARY OF INVENTION

### Problems to be Solved by Invention

However, when the lens cover of the projector having the autofocus function is closed in order to interrupt the projection of the image during the break of the conference or the like, a person may frequently pass between the projector and the projection screen. In this case, the person passing between the projector and the projection screen may be erroneously detected as the projection screen by the autofocus function, creating a problem of unintended execution of focus adjustment. In particular, when a motor is used for focus adjustment, a motor control sound is generated. As a result, when unintended focus adjustment is executed, such a sound becomes offensive to the user.

It is therefore an object of the present invention to provide an image display device capable of solving the aforementioned problem, and a method for controlling the device.

### Brief Summary of the Invention

To achieve the object, according to the present invention, an image display device having a projection lens configured to project an image to a projection surface and an openable/closable lens cover for covering the front of the projection lens includes:

a focus adjustment control unit that adjusts the focus of the projection lens; and

an open/close detection unit that detects the opened/closed state of the lens cover to notify the focus adjustment control unit of the result,

wherein the focus adjustment control unit stops the focus adjustment when the focus adjustment control unit is notified of the closing of the lens cover by the open/close detection unit.

To achieve the object, according to the present invention, a method for controlling an image display device having a projection lens configured to project an image to a projection surface, an openable/closable lens cover for covering the front of the projection lens, a focus adjustment control unit configured to adjust the focus of the projection lens, and an open/close detection unit configured to detect the opened/closed state of the lens cover and to notify the focus adjustment control unit of the result, includes:

stopping, by the focus adjustment control unit, the focus adjustment when the open/close detection unit notifies the control unit that the lens cover is in a closed state, and adjusting the focus only when the open/close detection unit notifies the control unit that the lens cover is in the opened state.

### Effects of Invention

According to the present invention, the image display device detects the open/closed state of the lens cover for covering the front of the projection lens, and stops the focus adjustment when the lens cover is closed.

As a result, when the lens cover is closed and no image is displayed, unintended execution of focus adjustment can be prevented.

### BRIEF DESCRIPTION OF DRAWINGS

FIG. 1 is a block diagram showing the configuration of a projector according to the first exemplary embodiment of the present invention.

FIG. 2 is a flowchart showing an example of the operation of the projector shown in FIG. 1.

FIG. 3 a block diagram showing the configuration of a projector according to the second exemplary embodiment of the present invention.

FIG. 4 is a flowchart showing an example of the operation of the projector shown in FIG. 3.

### DESCRIPTION OF EXEMPLARY EMBODIMENTS

Hereinafter, the exemplary embodiments of the present invention are described referring to the accompanying drawings.

### First Exemplary Embodiment

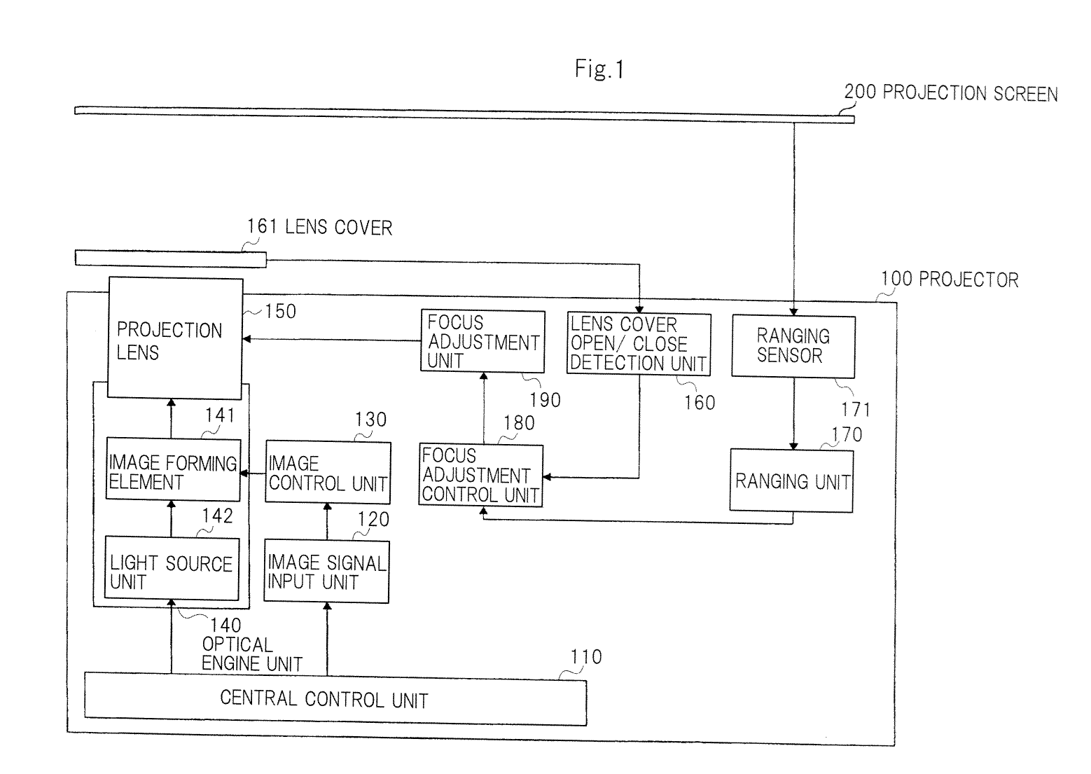

FIG. 1 is a block diagram showing the configuration of a projector according to the first exemplary embodiment of the present invention.

Projector 100 shown in FIG. 1 includes central control unit 110, image signal input unit 120, image control unit 130, optical engine unit 140, projection lens 150, lens cover open/close detection unit 160, lens cover 161, ranging unit 170, ranging sensor 171, focus adjustment control unit 180, and focus adjustment unit 190.

Optical engine unit 140 includes image forming element 141 and light source unit 142. Image forming element 141 is, for example, a transmissive liquid crystal display device having a general configuration, and thus detailed description thereof is omitted.

Central control unit 110, which controls the overall operation of projector 100, for example, inputs an image signal to image signal input unit 120 or lights light source unit 142.

Image signal input unit 120, which has received the image signal from central control unit 110, outputs the image signal to image control unit 130.

Image control unit 130 controls the image signal output from image signal input unit 120 to form an image at image forming element 141.

Light source unit 142 outputs light to illuminate image forming element 141.

Projection lens 150 magnifies the image formed by image forming element 141 illuminated with the light from light source unit 142 to project it to projection screen 200. Focus adjustment can be executed by moving the position of projection lens 150 by a motor.

Lens cover open/close detection unit 160 detects the opened/closed state of openable/closable lens cover 161 for covering the front of projection lens 150, and notifies focus adjustment control unit 180 of the result.

Ranging unit 170 continuously measures the distance from projector 100 to projection screen 200 by using ranging sensor 171, and outputs distance information indicating the measured distance to focus adjustment control unit 180.

Focus adjustment control unit 180 determines, for example, the operation of the motor necessary for moving projection lens 150 to a focusing position based on the distance information output from ranging unit 170, and instructs focus adjustment unit 190 to perform the operation. Focus adjustment control unit 180 stops the focus adjustment when it is notified of the closing of lens cover 161 by lens cover open/close detection unit 160.

Focus adjustment unit 190, which is, for example, a motor, adjusts the focus of projection lens 150 according to an instruction from focus adjustment control unit 180.

Next, the operation of projector 100 is described.

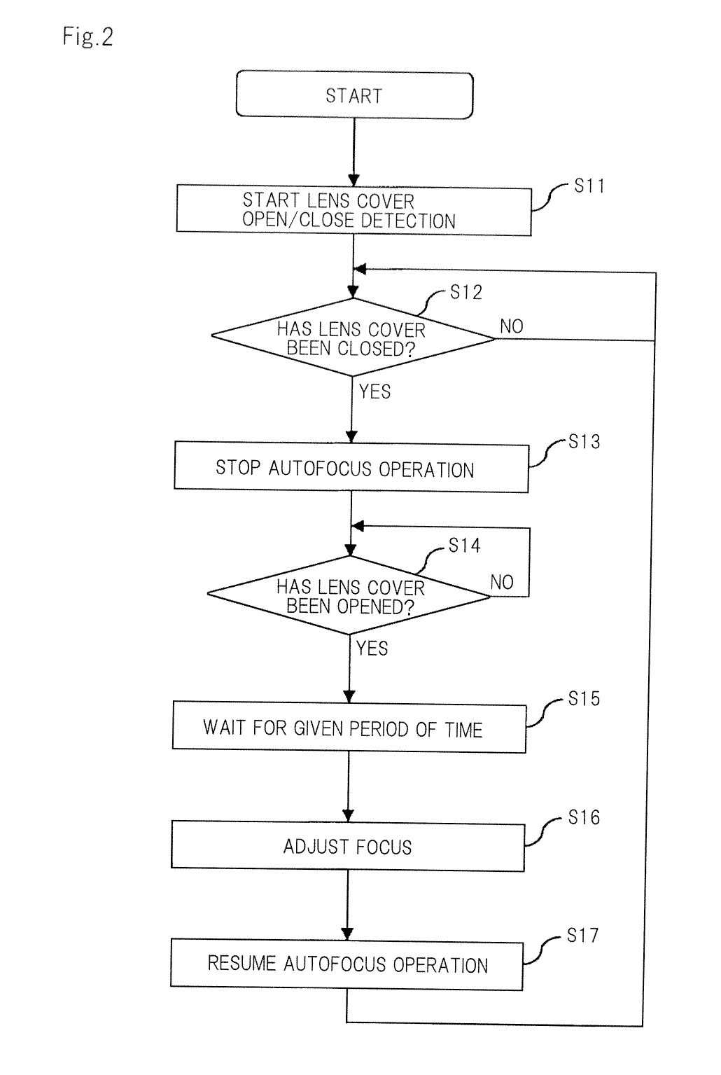

FIG. 2 is a flowchart illustrating an example of the operation of projector 100.

When projector 100 starts projection of an image, focus adjustment control unit 180 starts focus adjustment. Then, lens cover open/close detection unit 160 starts detection of the opened/closed state of lens cover 161 (at step S11), and determines whether lens cover 161 is in a closed state (at step S12).

When lens cover 161 is not in the closed state (at step S12: NO), lens cover open/close detection unit 160 notifies focus adjustment control unit 180 of this and repeats the operation of step S12. On the other hand, when lens cover 161 is in the closed state (at step S12: YES), lens cover open/close detection unit 160 notifies focus adjustment control unit 180 of this. Focus adjustment control unit 180 that has received the notification from lens cover open/close detection unit 160 stops the autofocus operation (at step S13).

Then, lens cover open/close detection unit 160 determines whether or not lens cover 161 is in an opened state (at step S14).

When lens cover 161 is not in the opened state (at step S14: NO), lens cover open/close detection unit 160 notifies focus adjustment control unit 180 of this and repeats the operation of step S14. On the other hand, when lens cover 161 is in the opened state, lens cover open/close detection unit 160 notifies focus adjustment control unit 180 of this. Focus adjustment control unit 180 that has received the notification from lens cover open/close detection unit 160 waits for a given period of time (at step S15), then adjusts the focus (at step S16), and resumes the autofocus operation (at step S17).

When lens cover 161 is in the opened/closed state, the installation position of projector 100 may be shifted or slightly moved. Therefore, focus adjustment control unit 180 waits, after it has been notified of the opened state of lens cover 161, for a given period of time, and then adjusts the focus after the shifting or the slight movement of the installation position has stopped. This enables projection of a stable image to projection screen 200.

According to this exemplary embodiment, projector 100 detects the opened/closed state of lens cover 161 and stops the focus adjustment when lens over 161 is in the closed state.

Thus, when lens cover 161 is closed to interrupt the projection of the image, unintended execution of focus adjustment can be prevented.

### Second Exemplary Embodiment

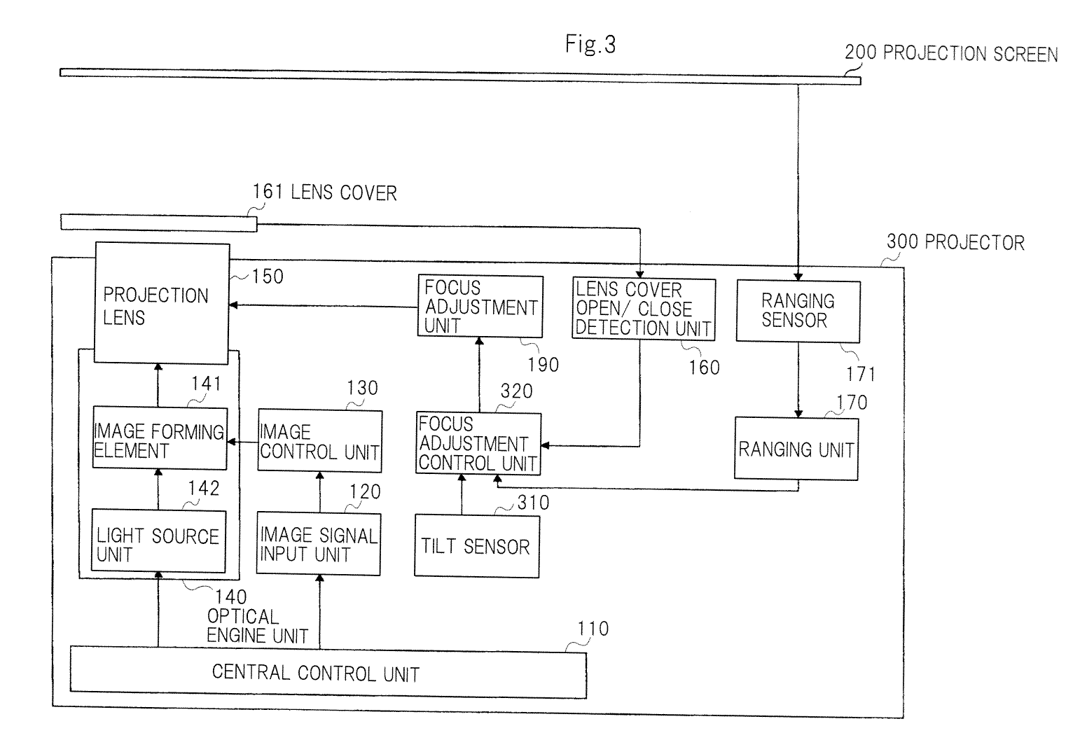

FIG. 3 is a block diagram showing the configuration of a projector according to the second exemplary embodiment of the present invention. Components shown in FIG. 3 similar to those shown in FIG. 1 are denoted by similar reference numerals, and description thereof is omitted.

Projector 300 shown in FIG. 3 is different from projector 100 of the first exemplary embodiment in that tilt sensor 310 is installed and focus adjustment control unit 180 is substituted to focus adjustment control unit 320.

Tilt sensor 310 detects the movement of projector 300 itself such as shifting or slight movement of the installation position to notify focus adjustment control unit 320 of the result.

To resume a stopped autofocus operation, focus adjustment control unit 320 determines whether projector 300 is static based on notification from tilt sensor 310, and adjusts the focus after determination that projector 300 is static.

Next, the operation of projector 300 is described.

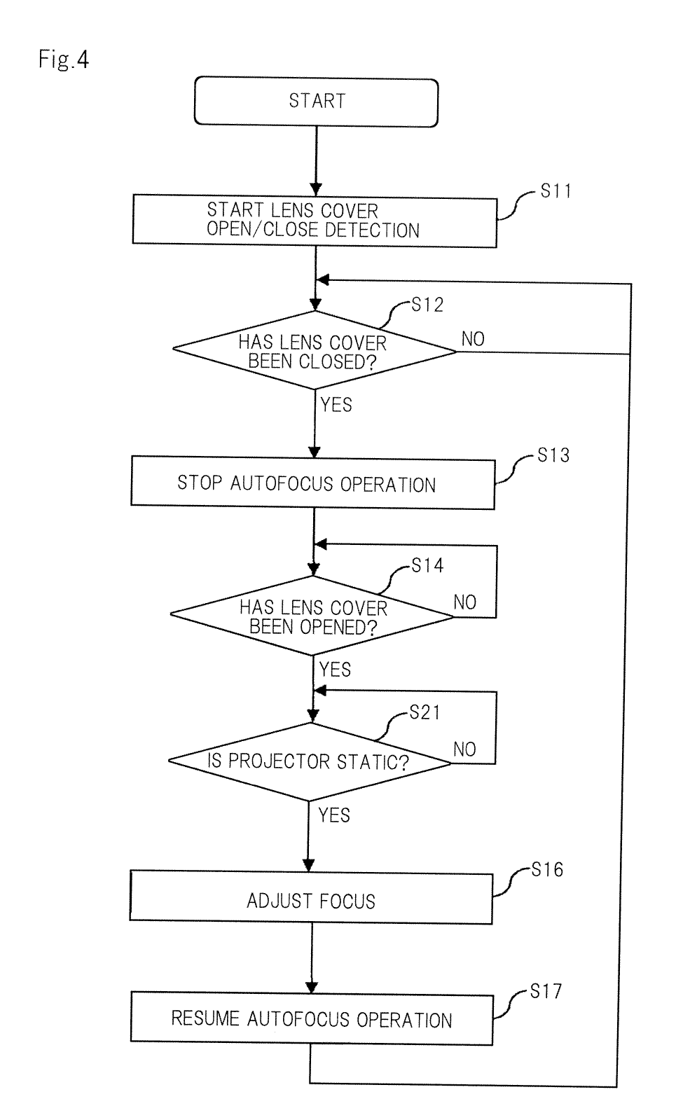

FIG. 4 is a flowchart showing an example of the operation of projector 300. Operation steps shown in FIG. 4 similar to those in FIG. 2 are denoted by similar reference numerals, and description thereof is omitted.

When lens cover 161 is in an opened state (at step S14: YES), focus adjustment control unit 320 determines whether projector 300 is static based on the detection result of the shifting or the slight movement of the installation position notified from tilt sensor 310 (at step S21).

When it is determined that projector 300 is not static (at step S21: NO), focus adjustment control unit 320 repeats the operation of step S21. On the other hand, when it is determined that projector 300 is static (at step S21: YES), focus adjustment control unit 320 adjusts the focus (at step S16).

According to this exemplary embodiment, in order to resume the stopped autofocus operation, projector 300 determines whether it is static itself, and adjusts the focus after determination that projector 300 is static.

Thus, since the focus is adjusted after the shifting or the slight movement of the installation position of projector 300 caused by the opening/closing of lens cover 161 has stopped, a stable image can be projected to projection screen 200.

Projector 300 can wait, as in the case of the first exemplary embodiment, for a given period of time after it has been notified of the opening of lens cover 161, and then determine whether projector 300 itself is static based on notification from tilt sensor 310, and adjust the focus when it is determined that the projector is static.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. An image display device having a projection lens configured to project an image to a projection surface and an openable/closable lens cover for covering a front of said projection lens, comprising:
a focus adjustment control unit that adjusts a focus of said projection lens; and
an open/close detection unit that detects an opened/closed state of said lens cover and notifies said focus adjustment control unit of a result,
wherein said focus adjustment control unit stops the focus adjustment when said focus adjustment control unit is notified of closing of said lens cover by said open/close detection unit.

2. The image display device according to claim 1, wherein said focus adjustment control unit adjusts the focus when said control unit is notified of opening of said lens cover by said open/close detection unit.

3. The image display device according to claim 1, wherein said focus adjustment control unit adjusts the focus after the elapse of a given period of time from notification of opening of said lens cover by said open/close detection unit.

4. The image display device according to claim 2, further comprising a tilt sensor that detects whether the image display device is in a static state, and notifies said focus adjustment control unit of a result,
wherein said focus adjustment control unit determines whether the image display device is in the static state based on the notification from said tilt sensor, and adjusts the focus after determination that the image display device is in the static state.

5. A method for controlling an image display device having a projection lens configured to project an image to a projection surface, an openable/closable lens cover for covering a front of said projection lens, a focus adjustment control unit configured to adjust a focus of said projection lens, and an open/close detection unit configured to detect an opened/closed state of said lens cover and to notify said focus adjustment control unit of a result, the method comprising:
stopping, by said focus adjustment control unit, the focus adjustment when said open/close detection unit notifies said control unit that said lens cover is in a closed state, and adjusting the focus only when said open/close detection unit notifies said control unit that said lens cover is in the opened state.

6. The method for controlling the image display device according to claim 5, wherein said focus adjustment control unit adjusts the focus after the elapse of a given period of time from notification of opening of the lens cover by said open/close detection unit.

7. The method for controlling the image display device according to claim 5, wherein said focus adjustment control unit determines whether the image display device is in a static state based on notification from a tilt sensor that detects whether the image display device is in the static state, and adjusts the focus after determination that the image display device is in the static state.

8. The image display device according to claim 3, further comprising a tilt sensor that detects whether the image display device is in a static state, and notifies said focus adjustment control unit of a result,
wherein said focus adjustment control unit determines whether the image display device is in the static state based on the notification from said tilt sensor, and adjusts the focus after determination that the image display device is in the static state.

9. The method for controlling the image display device according to claim 6, wherein said focus adjustment control unit determines whether the image display device is in a static state based on notification from a tilt sensor that detects whether the image display device is in the static state, and adjusts the focus after determination that the image display device is in the static state.
